(19) United States
(12) Patent Application Publication
(10) Pub. No.: US 2025/0037947 A1
(43) Pub. Date: Jan. 30, 2025

(54) BUTTON DEVICE ATTACHABLE TO TOUCH SCREEN

(71) Applicant: KORTEK CORPORATION, Incheon (KR)

(72) Inventor: Kyung In Seo, Incheon (KR)

(21) Appl. No.: 18/708,625

(22) PCT Filed: Oct. 6, 2022
(86) PCT No.: PCT/KR2022/015032

§ 371 Date: Oct. 16, 2024

(30) Foreign Application Priority Data
Nov. 18, 2021 (KR) 10-2021-0159558

(51) Int. Cl. H01H 13/14; G06F 3/039; H01H 13/10

(52) U.S. Cl. CPC H01H 13/14; G06F 3/0393; H01H 13/10

(57) ABSTRACT

A button device that is attachable to a touchscreen is provided, the button device including: a base adhered and fixed to a surface of a touchscreen is push button disposed to overlap with the base and be able to move upward and downward relative to the base and having a central portion and a flange portion stepped from an outer boundary of the central portion and expanding outward; a bezel placed on the push button to expose the central portion and cover the flange portion and detachably coupled to the base; and a through-base conductor having an upper side passing through the base in an up-down direction and a lower side coming in contact with the surface of the touchscreen.

### CROSS-REFERENCE TO RELATED APPLICATIONS

This application is a national application of PCT Application No. PCT/KR2022/015032, having a filing date of Oct. 6, 2022, claiming priority to KR Application No. 10-2021-0159558, having a filing date of Nov. 18, 2021, the entire contents both of which are hereby incorporated by reference.

### FIELD OF TECHNOLOGY

The following relates to a button device that is attachable to a touchscreen that is attached to an electrostatic touchscreen and allows a specific instruction to be input on the touchscreen when pressed and an electronic device having the button device.

### BACKGROUND

Touchscreens are applied not only to portable electronic devices such as smartphones, smart pads, and laptops but also to electronic devices for games such as slot machines in order to implement an intuitive, convenient user interface. However, when a user presses a touchscreen to input a specific instruction when playing a game using such an electronic device, interest and tension in the game may be decreased because there is almost no feeling of pressing felt by the hand when inputting the instruction. Also, the touchscreen may be easily damaged or malfunction due to only a specific portion of the touchscreen being repeatedly pressed hard.

Therefore, a button device that is installed on a touchscreen to allow a specific instruction to be input and allow a user to have a physical feeling of pressing when pressing the button device has been disclosed in Korean Patent Registration No. 10-2017637. However, protective glass on a front surface of the touchscreen is partially removed to install the button device, or a mounting hole is formed in the protective glass and a wire passing through the mounting hole is used to energizably connect the button device and the touchscreen. As a result, costs for a task of installing the button device on the touchscreen increase, and the time taken for the task increases. Also, liquid or foreign matter may easily enter an electronic device through the portion where the protective glass is removed or the mounting hole and cause failure.

The conventional art is disclosed in Korean Patent Registration No. 10-2017637 (Date of Registration: Aug. 28, 2019, Title: Button apparatus for casino machine).

### SUMMARY

An aspect relates to a button device that is attachable to a touchscreen that is completely installed on an electronic device by simply being attached to a touchscreen without cutting the touchscreen or forming a mounting hole in the touchscreen.

One aspect of embodiments of the present invention provide a button device that is attachable to a touchscreen, the button device including: a base fixed to a surface of a touchscreen; a push button disposed to overlap with the base and be able to move upward and downward relative to the base and having a central portion and a flange portion which is stepped from an outer boundary of the central portion and expands; a bezel placed on the push button to expose the central portion and cover the flange portion and detachably coupled to the base; and a through-base conductor having an upper portion passing through the base in an up-down direction and a lower portion energizably connected to the upper portion and coming in contact with the surface of the touchscreen, wherein the push button has an upper surface conductive layer laminated on at least an upper surface of the central portion of an upper surface of the push button, a lower surface conductive layer laminated on at least a lower surface of the flange portion of a lower surface of the push button, and a connecting conductive layer configured to energizably connect the upper surface conductive layer and the lower surface conductive layer and laminated on a surface of the push button, and the lower surface conductive layer and the upper portion of the through-base conductor come in contact with each other when the push button is pressed and moves downward.

In embodiments of the present invention, all of the conductive layers laminated on the surfaces of the push button may have a metal deposited on the surfaces of the push button.

In embodiments of the present invention, all of the conductive layers laminated on the surfaces of the push button may have an indium tin oxide (ITO) film attached to the surfaces of the push button.

In embodiments of the present invention, a lower side of the through-base conductor may come in contact with the surface of the touchscreen via a conductive material.

In embodiments of the present invention, the upper portion of the through-base conductor may have a conductive pin passing through the base and extending in the up-down direction, and the lower portion of the through-base conductor may have a conductive plate configured to come in contact with and support a lower end of the conductive pin and installed on the base.

In embodiments of the present invention, the button device may further include an elastic member configured to elastically press the push button for the push button to be biased upward and an elastic member support body configured to support the elastic member and be supported by being fastened to the bezel.

Another aspect of embodiments of the present invention provides a button device that is attachable to a touchscreen, the button device including: a base adhered and fixed to a surface of a touchscreen; a push button disposed to overlap with the base and be able to move upward and downward relative to the base and having a central portion and a flange portion stepped from an outer boundary of the central portion and expanding outward; a bezel placed on the push button to expose the central portion and cover the flange portion and detachably coupled to the base; a through-base conductor having an upper portion passing through the base in an up-down direction and a lower portion energizably connected to the upper portion and coming in contact with the surface of the touchscreen; and a fixed-to-push-button conductor fixed to and supported by a lower surface of the flange portion of the push button, wherein the push button has an upper surface conductive layer laminated on at least an upper surface of the central portion of an upper surface of the push button, and a connecting conductive layer configured to energizably connect the upper surface conductive layer and the fixed-to-push-button conductor and laminated on a surface of the push button, and the fixed-to-push-button conductor and the upper portion of the through-base conductor come in contact with each other when the push button is pressed and moves downward.

In embodiments of the present invention, all of the conductive layers laminated on the surfaces of the push button may have a metal deposited on the surfaces of the push button.

In embodiments of the present invention, all of the conductive layers laminated on the surfaces of the push button may have an indium tin oxide (ITO) film attached to the surfaces of the push button.

In embodiments of the present invention, a lower side of the through-base conductor may come in contact with the surface of the touchscreen via a conductive material.

In embodiments of the present invention, the upper portion of the through-base conductor may have a conductive pin passing through the base and extending in the up-down direction, and the lower portion of the through-base conductor may have a conductive plate configured to come in contact with and support a lower end of the conductive pin and installed on the base.

In embodiments of the present invention, the button device may further include an elastic member configured to elastically press the push button for the push button to be biased upward and an elastic member support body configured to support the elastic member and be supported by being fastened to the bezel.

According to embodiments of the present invention, a button device that is attachable to a touchscreen is completely installed on an electronic device by simply being attached to an electrostatic touchscreen without cutting the touchscreen or forming a mounting hole in the touchscreen. Therefore, costs for a task of installing the button device on the touchscreen decrease, and the time taken for the task decreases. Also, since liquid foreign matter does not enter the electronic device through a damaged portion of protective glass of the touchscreen, internal contamination of the electronic device or failure thereof due to the internal contamination is prevented.

According to a button device that is attachable to a touchscreen according to an embodiment of the present invention that has a fixed-to-push-button conductor, even when a user presses a push button with a hand wearing a glove which is a nonconductor or presses the push button using a tool which is a nonconductor, capacitance of the fixed-to-push-button conductor itself is sufficient, and thus pressing on the push button is detected on the touchscreen. Therefore, a specific intended instruction can be input to an electronic device by pressing the push button.

### BRIEF DESCRIPTION

Some of the embodiments will be described in detail, with references to the following Figures, wherein like designations denote like members, wherein:

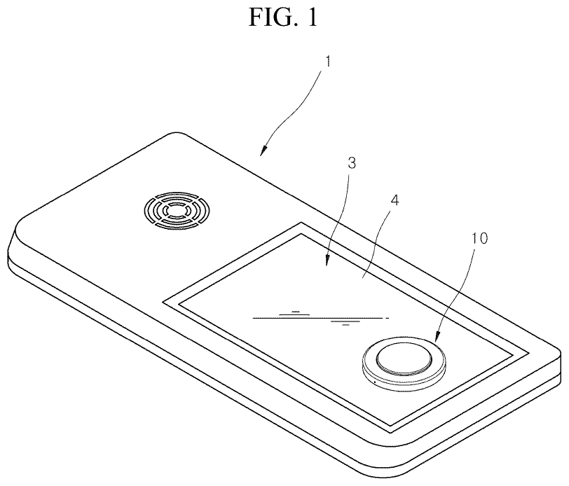

FIG. 1 is a perspective view illustrating an electronic device having a button device that is attachable to a touchscreen according to an embodiment of the present invention;

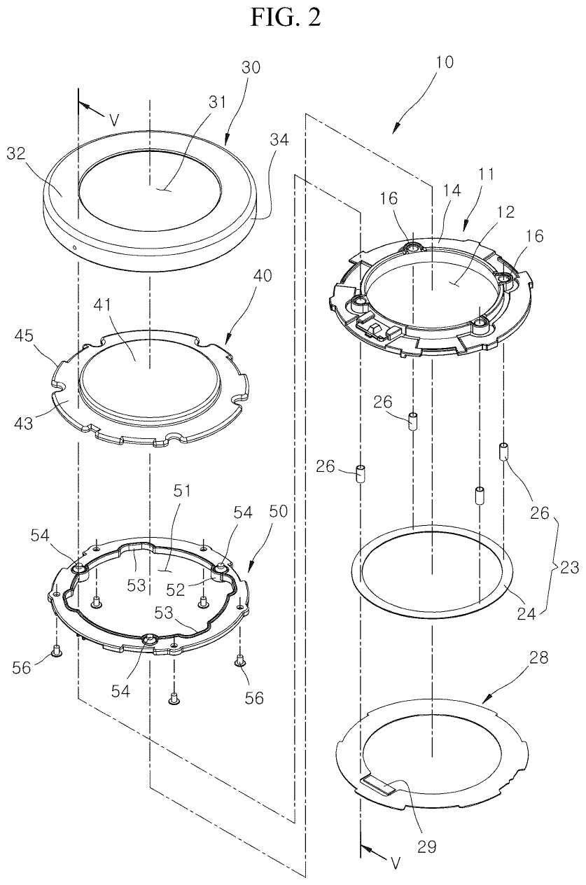

FIG. 2 is an exploded perspective view of the button device that is attachable to a touchscreen according to an embodiment of the present invention from above;

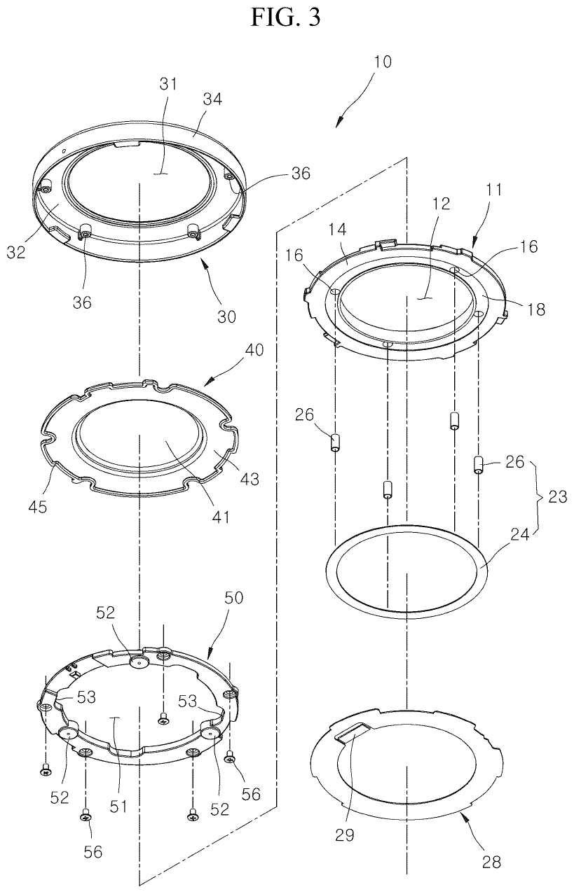

FIG. 3 is an exploded perspective view of the button device that is attachable to a touchscreen according to an embodiment of the present invention from below;

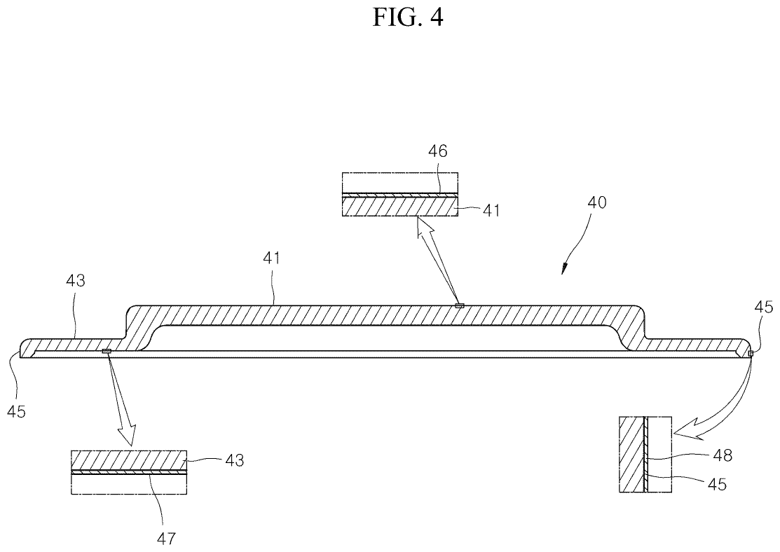

FIG. 4 is a longitudinal cross-sectional view of a push button of FIG. 2;

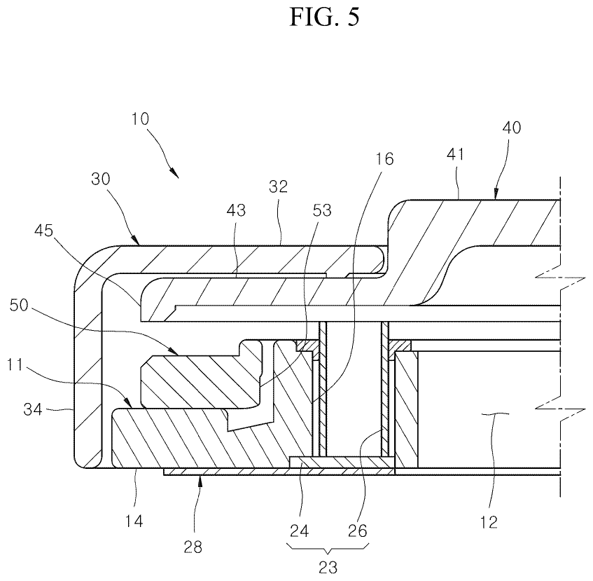

FIG. 5 is a longitudinal cross-sectional view along V-V of FIG. 2; and

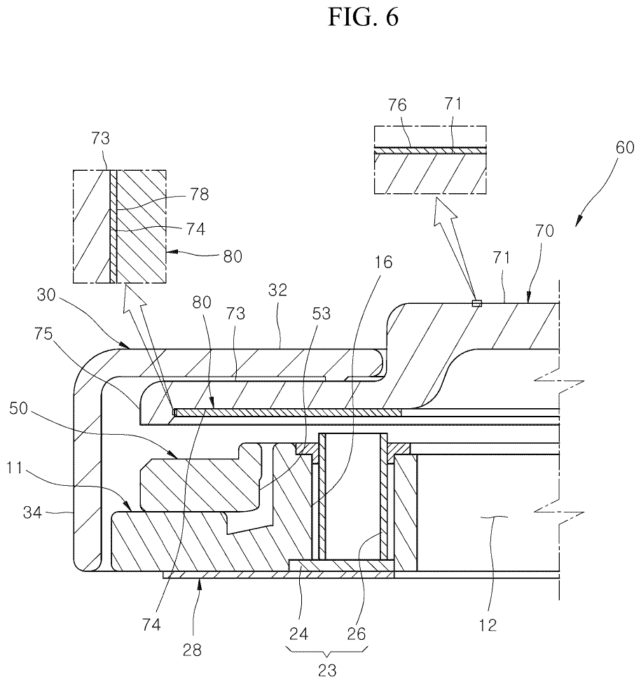

FIG. 6 is a longitudinal cross-sectional view of a button device that is attachable to a touchscreen according to an embodiment of the present invention.

### DETAILED DESCRIPTION

Hereinafter, a button device that is attachable to a touchscreen according to an embodiment of the present invention will be described in detail with reference to the accompanying drawings. Terms used herein are terms used to appropriately describe exemplary embodiments of the present invention and may be changed according to an intention of a user or an operator or customary practice in the conventional art to which embodiments of the present invention pertains. Therefore, the terms should be defined based on the content throughout the present specification.

FIG. 1 is a perspective view illustrating an electronic device having a button device that is attachable to a touchscreen according to an embodiment of the present invention. Referring to FIG. 1, an electronic device 1 having a button device 10 that is attachable to a touchscreen according to an embodiment of the present invention is an electronic device having a touchscreen 3, and specifically, may be a smart pad.

The electronic device to which the button device 10 of embodiments of the present invention is attached is not limited to a smart pad, and for example, embodiments of the present invention may also be applied to electronic devices for games such as slot machines as well as portable electronic devices such as smartphones and laptops.

The touchscreen 3 has a display panel, a touch detecting unit, and a protective glass 4. The display panel is a device on which a still image or a moving image is displayed. The touch detecting unit detects a user touching a specific point and is installed on the display panel to overlap therewith.

The touch detecting unit is a capacitive touch detecting unit and may be a touch panel or a touch film that is thinner and more flexible than the touch panel. The touch detecting unit has a plurality of first touch detecting electrodes (not illustrated) spaced apart from each other and extending in the horizontal direction and a plurality of second touch detecting electrodes (not illustrated) spaced apart from each other and extending in the vertical direction.

The first and second touch detecting electrodes may be formed of transparent indium tin oxide (ITO). The protective glass 4 is installed on the touch detecting unit to overlap therewith. In other words, the first and second touch detecting electrodes are positioned under the protective glass 4.

FIG. 2 is an exploded perspective view of the button device that is attachable to a touchscreen according to an embodiment of the present invention from above, FIG. 3 is an exploded perspective view of the button device that is attachable to a touchscreen according to an embodiment of the present invention from below, FIG. 4 is a longitudinal cross-sectional view of a push button of FIG. 2, and FIG. 5 is a longitudinal cross-sectional view along V-V of FIG. 2.

Referring to FIGS. 1 to 5, the button device 10 that is attachable to a touchscreen is a device allowing a user to promptly and intuitively input a specific instruction while using the electronic device 1 and has a base 11, a through-base conductor 23, a push button 40, a bezel 30, an elastic member support body 50, a plurality of elastic members 54, and a double-sided adhesive tape 28.

The base 11 is adhered and fixed to a surface of the touchscreen 3, specifically, an upper surface of the protective glass 4. Although the base 11 is detachably attached to the protective glass 4 using the double-sided adhesive tape 28 in an embodiment of the present invention, the base 11 may be attached to the protective glass 4 using other means such as an adhesive. The base 11 is a substantially ring-shaped member having a hollow 12 formed therein and has a flat portion 14 formed to be flat at an outer side of the hollow 12 and having an inner circumferential edge that limits the hollow 12. A plurality of pin through-holes 16 passing through the base 11 in an up-down direction are formed around the inner circumferential edge of the flat portion 14 in the base 11.

The through-base conductor 23 has an upper portion passing through the base 11 in the up-down direction and a lower portion energizably connected to the upper portion of the through-base conductor 23 and coming in contact with the surface of the touchscreen 3, specifically, the upper surface of the protective glass 4.

The upper portion of the through-base conductor 23 has a plurality of conductive pins 26 fitted to the plurality of pin through-holes 16 to pass through the base 11. The lower portion of the through-base conductor 23 has a conductive plate 24 configured to come in contact with and support lower ends of the plurality of conductive pins 26 and installed on the base 11.

The conductive pins 26 may be made of a metal material or a material including a base material made of a synthetic resin and a metal powder evenly dispersed in the base material. The conductive pins 26 may each have a tubular shape having a hollow formed therein to reduce the weight and reduce the amount of used material. Upper ends of the conductive pins 26 protrude slightly higher than an upper end of the base 11.

The conductive plate 24 extends in a closed loop shape such as a ring shape to come in contact with and support all of the conductive pins 26 and not cross the hollow 12 of the base 11. A conductive plate mounting groove 18 with a recessed step for installing the conductive plate 24 is formed in a lower surface of the flat portion 14 of the base 11.

The push button 40 is disposed to overlap with the base 11 and be able to move upward and downward relative to the base 11. The push button 40 has a central portion 41 positioned to be vertically aligned with the hollow 12 of the base 11 and through which an image displayed on the display panel of the touchscreen 3 (see FIG. 1) is visible and a flange portion 43 stepped from an outer boundary of the central portion 41 and expanding outward. The central portion 41 may have a lens configured to zoom in or out on the image on the display panel exposed through the hollow 12 or a filter configured to impart a visual effect to the image.

The bezel 30 is a ring-shaped member having a hollow 31, which corresponds to the central portion 41, formed therein to expose the central portion 41 of the push button 40. The bezel 30 is placed on the push button 40 to expose the central portion 41 of the push button 40 and cover the flange portion 43 and is detachably coupled to the base 11. The bezel 30 has an inner circumferential portion 32 configured to limit the hollow 31 and an outer circumferential portion 34 extending to be bent downward from the inner circumferential portion 32.

The plurality of elastic members 54 elastically press the push button 40 for the push button 40 to be biased upward. In an embodiment, the plurality of elastic members 54 may be formed of a rubber material or include a coil spring. The plurality of elastic members 54 come in contact with a lower surface of the flange portion 43 of the push button 40 and elastically support the push button 40.

The elastic member support body 50 supports the plurality of elastic members 54 and has a plurality of elastic member holders recessed in the shapes of grooves wherein the plurality of elastic members 54 are seated. The elastic member support body 50 is a ring-shaped member wherein a hollow 51 vertically aligned with the hollow 12 of the base 11 is formed, and a plurality of avoidance dents 53 recessed outward to not block the plurality of conductive pins 26 are formed in an inner surface of the elastic member support body 50 that limits the hollow 51.

The elastic member support body 50 is supported by being fastened to the bezel 30 using a plurality of bolts 56, and a lower surface of the elastic member support body 50 may come in contact with the flat portion 14 of the base 11. The reference numeral “36” denotes a plurality of bosses protruding from a lower surface of the inner circumferential portion 32 of the bezel 30 to be fastened to the plurality of bolts 56.

The push button 40 has an upper surface conductive layer 46 laminated on an upper surface of the central portion 41 and an upper surface of the flange portion 43, a lower surface conductive layer 47 laminated on the lower surface of the flange portion 43, and a connecting conductive layer 48 configured to energizably connect the upper surface conductive layer 46 and the lower surface conductive layer 47 and laminated on a surface of the push button 40. The upper surface conductive layer 46, the lower surface conductive layer 47, and the connecting conductive layer 48 may be formed by thinly depositing a metal on a surface of the push button 40. The connecting conductive layer 48 may be formed to cover an outer circumferential edge 45 of the flange portion 43 and energizably connect the upper surface conductive layer 46 and the lower surface conductive layer 47.

When a metal is also deposited on a lower surface of the central portion 41, transparency of the central portion 41 may be decreased, and a Moiré pattern may occur when a user views an image shown on the touchscreen 3 (see FIG. 1) through the central portion 41. In an embodiment, the lower surface conductive layer may not be laminated and formed on the lower surface of the central portion 41. Also, the upper surface conductive layer may not be laminated and formed on the upper surface of the flange portion 43 as long as the connecting conductive layer 48 can be formed to connect the upper surface conductive layer 46 and the lower surface conductive layer 47.

In the button device 10 that is attachable to a touchscreen according to embodiments of the present invention, the upper surface conductive layer, the lower surface conductive layer, and the connecting conductive layer are not limited to being formed by depositing a metal. In an embodiment, the upper surface conductive layer, the lower surface conductive layer, and the connecting conductive layer may also be formed by attaching an ITO film to a surface of the push button 40. In this case, an ITO film cut in the shape of a mesh may be attached to a surface of the push button 40 to form the upper surface conductive layer, the lower surface conductive layer, and the connecting conductive layer.

The double-sided adhesive tape 28 is a medium that adheres and fixes the base 11 to a surface of the touchscreen 3, that is, the upper surface of the protective glass 4. The double-sided adhesive tape 28 is cut substantially in a ring shape to correspond to the shape of the base 11. When the base 11 is attached to the surface of the touchscreen 3 via the double-sided adhesive tape 28, most of the lower surface of the conductive plate 24 is covered by the double-sided adhesive tape 28.

One portion of the lower surface of the conductive plate 24 that is not covered by the double-sided adhesive tape 28 comes in contact with the surface of the touchscreen 3, that is, the upper surface of the protective glass 4, via a conductive material 29. While the double-sided adhesive tape 28 is a double-sided adhesive tape that is nonconductive, the conductive material 29 may be a double-sided adhesive tape that is conductive. Alternatively, the conductive material 29 may be a conductive sheet or a conductive material in the form of sol or gel that is interposed between the lower surface of the conductive plate 24 and the upper surface of the protective glass 4 without adhesiveness.

Unlike in the drawings, the lower portion of the through-base conductor provided in the button device that is attachable to a touchscreen according to embodiments of the present invention may directly come in contact with the surface of the touchscreen 3 without a medium. In this case, the through-base conductor may have a portion protruding downward to come in contact with the surface of the touchscreen 3.

When the central portion 41 of the push button 40 is pressed by the user's hand and the push button 40 moves downward while the button device 10 is attached to the surface of the touchscreen 3, the lower surface conductive layer 47, which is laminated on the lower surface of the flange portion 43 of the push button 40, and the upper ends of the plurality of conductive pins 26 directly come in contact with each other.

Here, electrostatic energy caused by the capacitance of the user's body is transferred to the touch detecting unit (not illustrated) of the touchscreen 3 by passing through the upper surface conductive layer 46, the connecting conductive layer 48, the lower surface conductive layer 47, the plurality of conductive pins 26, the conductive plate 24, the conductive material 29, and the protective glass 4. Accordingly, when the user presses the push button 40, a specific intended instruction is input to the electronic device 1 through the button device 10 that is attachable to a touchscreen. When a force pressing the push button 40 is released, the push button 40 moves upward to its original position due to an elastic force of the plurality of elastic members 54, and the push button 40 is spaced apart from the plurality of conductive pins 26.

The above-described button device 10 that is attachable to a touchscreen is completely installed by simply being attached to the electrostatic touchscreen 3 without cutting the touchscreen 3 or forming a mounting hole in the touchscreen 3. Therefore, costs for a task of installing the button device 10 on the touchscreen 3 decrease, and the time taken for the task is decreased. Also, since liquid foreign matter does not enter the electronic device 1 through a damaged portion of the protective glass 4 of the touchscreen, internal contamination of the electronic device 1 or failure thereof due to the internal contamination is prevented.

FIG. 6 is a longitudinal cross-sectional view of a button device that is attachable to a touchscreen according to an embodiment of the present invention. Referring to FIGS. 1 to 6, a button device 60 that is attachable to a touchscreen according to an embodiment of the present invention is a device allowing a user to promptly and intuitively input a specific instruction while using the electronic device 1 and has a base 11, a through-base conductor 23, a push button 70, a fixed-to-push-button conductor 80, a bezel 30, an elastic member support body 50, a plurality of elastic members (not illustrated), a double-sided adhesive tape 28, and a conductive material (not illustrated).

The base 11, the through-base conductor 23, the bezel 30, the elastic member support body 50, and the double-sided adhesive tape 28 are members that have the same forms and configurations and perform the same functions as the members of the same names provided in the button device 10 that is attachable to a touchscreen that have been described above with reference to FIGS. 2 to 5, and thus redundant description thereof will be omitted.

Meanwhile, since the plurality of elastic members and the conductive material that are not illustrated in FIG. 6 have the same forms and configurations and perform the same functions as the plurality of elastic members 54 and the conductive material 29 provided in the button device 10 that is attachable to a touchscreen that have been described above with reference to FIGS. 2 to 5, redundant description thereof will be omitted.

The push button 70 is disposed to overlap with the base 11 and be able to move upward and downward relative to the base 11. The push button 70 has a central portion 71 positioned to be vertically aligned with the hollow 12 of the base 11 and through which an image displayed on the display panel of the touchscreen 3 is visible and a flange portion 73 stepped from an outer boundary of the central portion 71 and expanding outward. The central portion 71 may have a lens configured to zoom in or out on the image on the display panel exposed through the hollow 12 or a filter configured to impart a visual effect to the image.

The fixed-to-push-button conductor 80 is a conductor fixed to and supported by a lower surface of the flange portion 73. The fixed-to-push-button conductor 80 may be a ring-shaped member having a hollow, which is aligned with the hollow 12 of the base 11, formed and may be formed of a metal material. A conductor fitting groove 74 recessed to be stepped to fit the fixed-to-push-button conductor 80 may be formed in a lower surface of the push button 70. When the push button 70 is pressed and moves downward, the fixed-to-push-button conductor 80 and upper ends of a plurality of conductive pins 26 may directly come in contact with each other, and when the pressing force is released, the push button 70 moves upward to its original position due to an elastic force of the plurality of elastic members (not illustrated), and the fixed-to-push-button conductor 80 and the plurality of conductive pins 26 are spaced apart from each other.

The push button 70 has an upper surface conductive layer 76 laminated on an upper surface of the central portion 71 and an upper surface of the flange portion 73, and a connecting conductive layer 78 configured to energizably connect the upper surface conductive layer 76 and the fixed-to-push-button conductor 80 and laminated on a surface of the push button 70. The upper surface conductive layer 76 and the connecting conductive layer 78 may be formed by thinly depositing a metal on a surface of the push button 70. The connecting conductive layer 78 may be formed to cover an outer circumferential edge 75 of the flange portion 73 and energizably connect the upper surface conductive layer 76 and the fixed-to-push-button conductor 80. The upper surface conductive layer may not be laminated and formed on the upper surface of the flange portion 73 as long as the connecting conductive layer 78 can be formed to connect the upper surface conductive layer 76 and the fixed-to-push-button conductor 80.

Meanwhile, in the button device 60 that is attachable to a touchscreen according to an embodiment of the present invention, the upper surface conductive layer and the connecting conductive layer are not limited to being formed by depositing a metal. In an embodiment, the upper surface conductive layer and the connecting conductive layer may also be formed by attaching an ITO film to a surface of the push button 70. In this case, an ITO film cut in the shape of a mesh may be attached to a surface of the push button 70 to form the upper surface conductive layer and the connecting conductive layer.

In the button device 10 that is attachable to a touchscreen that has been described above with reference to FIGS. 2 to 5, since the upper surface conductive layer 46, the lower surface conductive layer 47, and the connecting conductive layer 48 are very thin, the capacitance of the button device 10 itself is insufficient. As a result, when a user presses the push button 40 with a hand wearing a glove which is a nonconductor or presses the push button 40 using a tool which is a nonconductor, the touch detecting unit of the touchscreen 3 may not detect the push button 40 being pressed, and a specific intended instruction may not be input to the electronic device 1 through the button device 10 that is attachable to a touchscreen.

However, since the fixed-to-push-button conductor 80 provided in the button device 60) that is attachable to a touchscreen illustrated in FIG. 6 is formed of a metal material and formed in a ring shape having a diameter larger than an inner diameter of the hollow 12 of the base 11, capacitance of the fixed-to-push-button conductor 80 itself is sufficiently high. Therefore, even when a user presses the push button 70 with a hand wearing a glove which is a nonconductor or presses the push button 70 using a tool which is a nonconductor, and the fixed-to-push-button conductor 80 and the upper ends of the plurality of conductive pins 26 directly come in contact with each other, electrostatic energy caused by the capacitance of the fixed-to-push-button conductor 80 itself is transferred to the touch detecting unit (not illustrated) of the touchscreen 3 by passing through the plurality of conductive pins 26, the conductive plate 24, the conductive material (not illustrated), and the protective glass 4. Accordingly, when the user presses the push button 70, a specific intended instruction is input to the electronic device 1 through the button device 60 that is attachable to a touchscreen.

Meanwhile, when the user presses the push button 70 with a bare hand, electrostatic energy caused by the capacitance of the user's body is transferred to the touch detecting unit (not illustrated) of the touchscreen 3 by passing through the upper surface conductive layer 76, the connecting conductive layer 78, the fixed-to-push-button conductor 80, the plurality of conductive pins 26, the conductive plate 24, the conductive material (not illustrated), and the protective glass 4, and accordingly, when the user presses the push button 70, a specific intended instruction is input to the electronic device 1 through the button device 60 that is attachable to a touchscreen.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A button device that is attachable to a touchscreen, the button device comprising:
a base fixed to a surface of a touchscreen;
a push button disposed to overlap with the base and be able to move upward and downward relative to the base and having a central portion and a flange portion which is stepped from an outer boundary of the central portion and expands;
a bezel placed on the push button to expose the central portion and cover the flange portion and detachably coupled to the base; and
a through-base conductor having an upper portion passing through the base in an up-down direction and a lower portion energizably connected to the upper portion and coming in contact with the surface of the touchscreen;
wherein the push button has an upper surface conductive layer laminated on at least an upper surface of the central portion of an upper surface of the push button, a lower surface conductive layer laminated on at least a lower surface of the flange portion of a lower surface of the push button, and a connecting conductive layer configured to energizably connect the upper surface conductive layer and the lower surface conductive layer and laminated on a surface of the push button; and
the lower surface conductive layer and the upper portion of the through-base conductor come in contact with each other when the push button is pressed and moves downward.

2. The button device of claim 1, wherein all of the conductive layers laminated on the surfaces of the push button have a metal deposited on the surfaces of the push button.

3. The button device of claim 1, wherein all of the conductive layers laminated on the surfaces of the push button have an indium tin oxide film attached to the surfaces of the push button.

4. The button device of claim 1, wherein a lower side of the through-base conductor comes in contact with the surface of the touchscreen via a conductive material.

5. The button device of claim 1, wherein:
the upper portion of the through-base conductor has a conductive pin passing through the base and extending in the up-down direction; and
the lower portion of the through-base conductor has a conductive plate configured to come in contact with and support a lower end of the conductive pin and installed on the base.

6. The button device of claim 1, further comprising:
an elastic member configured to elastically press the push button for the push button to be biased upward; and
an elastic member support body configured to support the elastic member and be supported by being fastened to the bezel.

7. A button device that is attachable to a touchscreen, the button device comprising:
a base adhered and fixed to a surface of a touchscreen;
a push button disposed to overlap with the base and be able to move upward and downward relative to the base and having a central portion and a flange portion stepped from an outer boundary of the central portion and expanding outward;
a bezel placed on the push button to expose the central portion and cover the flange portion and detachably coupled to the base;
a through-base conductor having an upper portion passing through the base in an up-down direction and a lower portion energizably connected to the upper portion and coming in contact with the surface of the touchscreen; and
a fixed-to-push-button conductor fixed to and supported by a lower surface of the flange portion of the push button;
wherein the push button has an upper surface conductive layer laminated on at least an upper surface of the central portion of an upper surface of the push button, and a connecting conductive layer configured to energizably connect the upper surface conductive layer and the fixed-to-push-button conductor and laminated on a surface of the push button; and
the fixed-to-push-button conductor and the upper portion of the through-base conductor come in contact with each other when the push button is pressed and moves downward.

8. The button device of claim 7, wherein all of the conductive layers laminated on the surfaces of the push button have a metal deposited on the surfaces of the push button.

9. The button device of claim 7, wherein all of the conductive layers laminated on the surfaces of the push button have an indium tin oxide, film attached to the surfaces of the push button.

10. The button device of claim 7, wherein a lower side of the through-base conductor comes in contact with the surface of the touchscreen via a conductive material.

11. The button device of claim 7, wherein:
the upper portion of the through-base conductor has a conductive pin passing through the base and extending in the up-down direction; and
the lower portion of the through-base conductor has a conductive plate configured to come in contact with and support a lower end of the conductive pin and installed on the base.

12. The button device of claim 7, further comprising;
an elastic member configured to elastically press the push button for the push button to be biased upward; and
an elastic member support body configured to support the elastic member and be supported by being fastened to the bezel.
